(19) United States
(12) Patent Application Publication
(10) Pub. No.: US 2011/0316213 A1
(43) Pub. Date: Dec. 29, 2011

(54) VISES WITH CLAMPING ASSEMBLY

(76) Inventor: Ten-Kun Chen, Taipei (TW)

(21) Appl. No.: 12/824,232

(22) Filed: Jun. 28, 2010

(51) Int. Cl. B25B 1/10

(52) U.S. Cl. 269/240

(57) ABSTRACT

A vises includes a base; a sliding track installed on the base; a lower side of the sliding track being formed with a sliding groove; a main clamping arm extending upwards from the sliding track; a main extension arm extending at an upper side of the main clamping arm; a threaded rod screwed to a threaded hole in the sliding track; a sub-clamping arm extending from an upper side of the sliding body; a sub-extension arm extends from sub-clamping arm and toward the main extension arm of the main clamping arm; a sliding body having a part received in the sliding groove of the sliding track. The main clamping arm is symmetrical to the sub-clamping arm; and therefore, the main extension arm and the sub-extension arm can clamp a large work piece or a standing object steadily with large clamping areas and without releasing.

### FIELD OF THE INVENTION

The present invention relates to vises, and in particular to a vises with a main clamping arm and a sub-clamping arm which can be extended from right side or lift side so as to clamp a work piece or a standing object steadily. In working the work piece will not release so that the operator can work easily with a desire aspect and less force is used.

### BACKGROUND OF THE INVENTION

Referring to FIG. 1, a prior art vises is illustrated. The vises have a body 11 and a sliding body 12. The body 11 has a sliding track 111 with a groove therein for moveably receiving the sliding body 12. An inner side of the sliding track 111 is formed with an inner threaded hole (not shown) for receiving a threaded rod 13. The threaded rod is installed to the sliding body 12. A handle 14 serves to rotate the threaded rod 13 to drive the sliding body 12 to move forwards or backwards. The body 11 is installed with a main clamping arm 11 and the sliding body 12 is installed with a sub-clamping arm 121.

When the handle 14 is rotated, the threaded rod 13 will be driven to drive the sliding body 12 and the sub-clamping arm 121 to move forwards or backwards. The sub-clamping arm 121 and the main clamping arm 112 clamp or release a work piece. Since the main clamping arm 112 and the sub-clamping arm 121 are symmetrical and the area for clamping is finite. When a standing form object is desired to be clamped, it can't be clamped steadily. As illustrated in FIG. 2, the work piece 15 will slide out (it can be compared with that illustrated in FIG. 5). If the work piece 15 is to long and one end thereof is clamped, while another end is machined, the gravitation center will be unsteadily, even the work piece 15 will vibrate so that it is difficult to be machined. This makes trouble to users.

Furthermore, the threaded rod 13 is screwed to the body 11. It is time consumed. Although the connection areas are coated with lubricating oil, its effect is finite. Thus a large force for rotating the handle 14 is needed.

### SUMMARY OF THE INVENTION

The object of the present invention is to provide a vises with a clamping assembly, which has a main extension arm and a sub-extension arm for clamping large work piece and standing object steadily without releasing.

Another object of the present invention is to provide a vises with a main extension arm and a sub-extension arm for clamping a standing object so that the operator can operate with a desired orientation and aspect.

A further object of the present invention is to provide a vises for clamping a round object,

A yet object of the present invention is to provides a vises with a handle for easy operation.

To achieve above object, the present invention provides a vises comprising: a main body includes the following elements. a base; a sliding track installed on the base; a lower side of the sliding track being formed with a sliding groove; a main clamping arm extending upwards from the sliding track; a main extension arm extending at an upper side of the main clamping arm; a threaded rod screwedly connected to a lower side of the sliding body; the threaded rod being screwed to a threaded hole in the sliding track; an end portion of the threaded rod having a handle for driving the threaded rod to rotate so as to move the sliding body forwards and backwards; a sub-clamping arm extending from an upper side of the sliding body; a sub-extension arm extends from sub-clamping arm and toward the main extension arm of the main clamping arm; a sliding body having a part received in the sliding groove of the sliding track; wherein the main extending arm extended toward the sub-extending arm and the main clamping arm is symmetrical to the sub-clamping arm; and therefore, the main extension arm and the sub-extension arm can clamp a large work piece steadily without releasing.

The various objects and advantages of the present invention will be more readily understood from the following detailed description when read in conjunction with the appended drawing.

### BRIEF DESCRIPTION OF THE DRAWINGS

FIG. 1 is a plane view of the prior art.

FIG. 2 is a plane schematic view showing the operation of the prior art vises.

FIG. 3 is a perspective view of the present invention.

FIG. 4 is a schematic cross sectional view of the present invention.

FIG. 5 is a plane schematic view showing that the present invention is used to clamp a stand form work piece.

FIG. 6 is a plane schematic view showing that the arm of the present invention is prolonged at the right side.

FIG. 7 is a schematic view about the bearing of the present invention.

FIG. 8 is a schematic view showing another embodiment of the present invention.

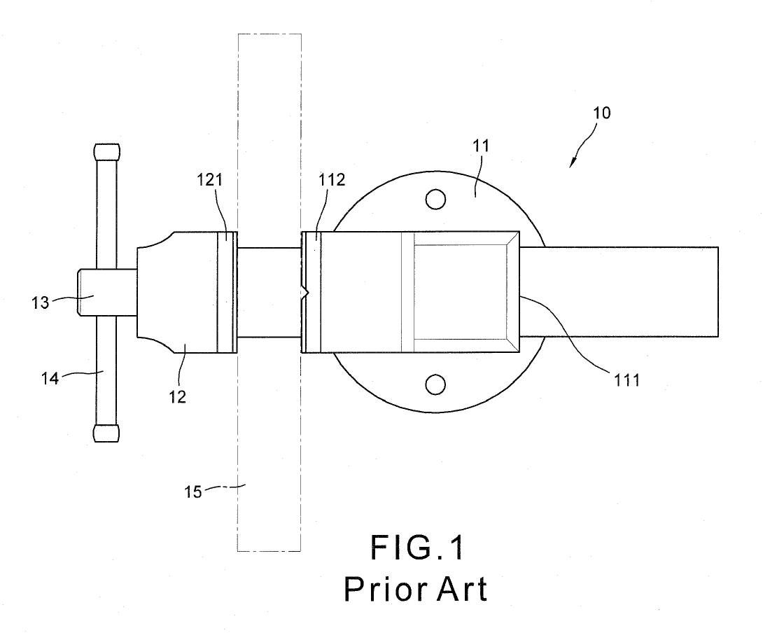

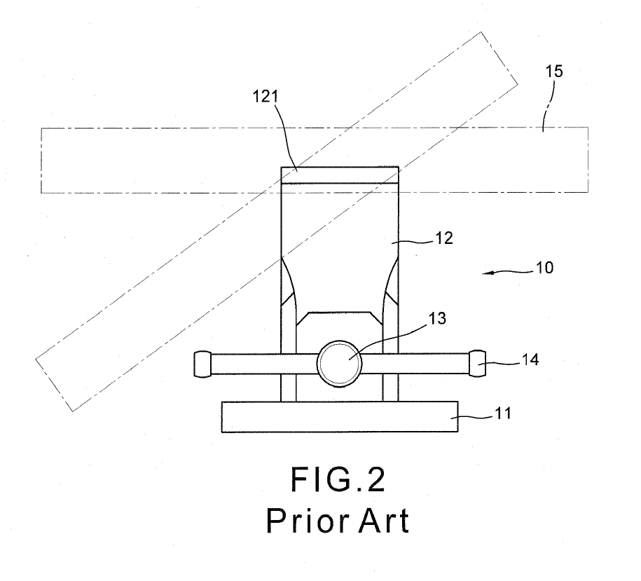

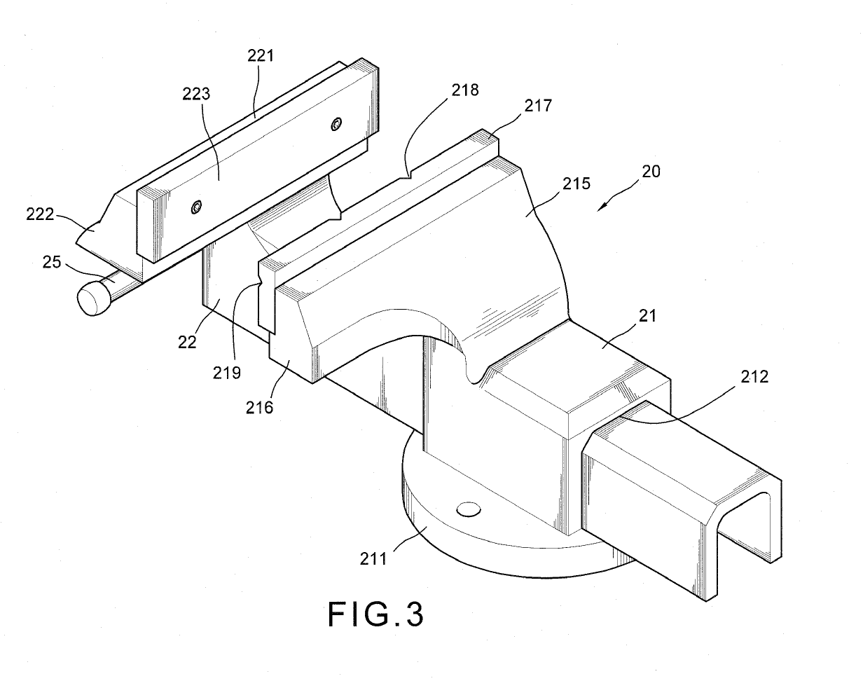

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The structure of the present invention will be described herein. The clamper 20 includes the following elements.

A main body 21 includes the following elements.

A base 211 may have a round shape or a rectangular shape.

A sliding track 212 is installed on the base 211 has an approximate U shape cross section. A lower side of the sliding track 212 is formed with a sliding groove.

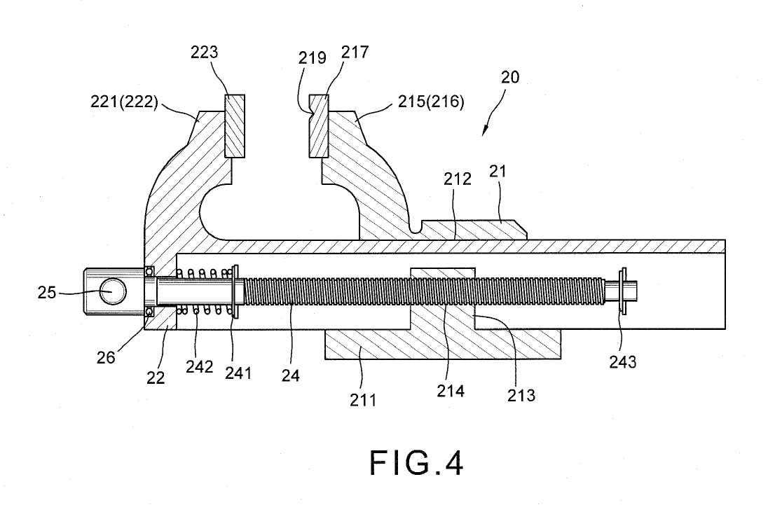

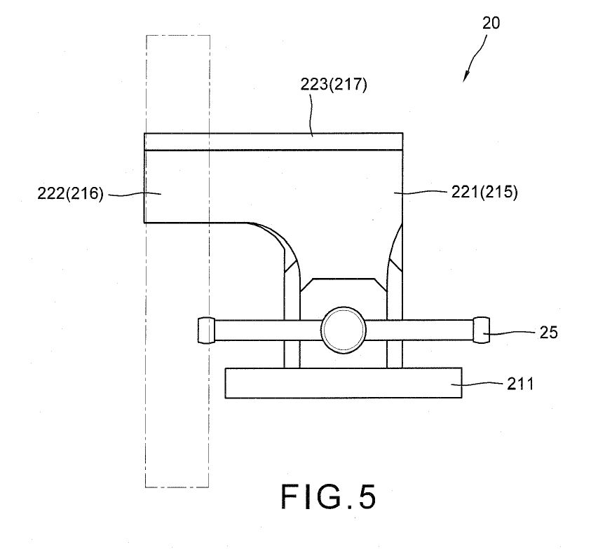

A protruding block 213 extends upwards from the base 211 (see FIG. 4). A threaded hole 214 is formed in the protruding block 213.

A main clamping arm 215 extends upwards from the sliding track 212.

A main extension arm 216 extends at the upper side of the main clamping arm 215. Thus the whole length of the main extension arm 216 and the main clamping arm 215 are larger than the general used main clamping arm.

A main clamping plate 217 is screwed to an inner side of the main extension arm 216. An inner side of the main clamping plate 217 is formed with a plurality of longitudinal trenches 218 (V shape trenches) and a plurality of transversal trenches 219 (V shape trenches) which are used to clamp a round cylindrical work piece steadily.

A sliding body 22 is included. A part of the sliding body 22 is movably received in the sliding groove of the sliding track 212.

A threaded rod 24 is pivotally connected to a lower side of the sliding body 22. The threaded rod 24 is screwed to the threaded hole 214 of the protruding block 213. An end portion of the threaded rod 24 has a handle 25 for driving the threaded rod 24 to rotate so as to move the sliding body 22 forwards and backwards. A positioning ring 241 is installed at another end of the threaded rod 24. A spring 242 is wound around the threaded rod 24 and is installed between the positioning ring 241 and a lower inner side of the sliding body 22 so that the spring 242 resists against the positioning ring 241 and the sliding body 22. A rear end of the threaded rod 24 is installed with another positioning ring 243 for stopping the protruding block 213.

A sub-clamping arm 221 extends from an upper side of the sliding body 22. A sub-extension arm 222 extends from sub-clamping arm 221 and toward the main extension arm 216 of the main clamping arm 215. An inner side of the sub-extension arm 222 has a sub-clamping plate 223.

The structure of the sub-clamping arm 221 is symmetrical to the structure of the main clamping arm 215.

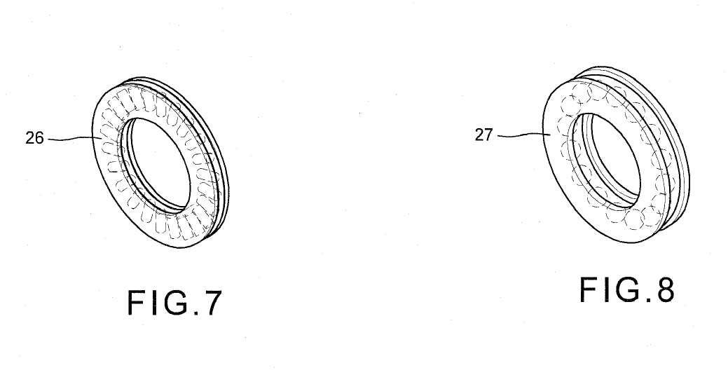

An end portion of the threaded rod 24 attached to the main body 21 has a bearing 26 (see FIG. 4 or FIG. 7) which surround the end portion of the threaded rod 24. The bearing 26 is a cylindrical round post bearing so as to reduce the friction force and the operation is easy with less force. Moreover, the threaded rod 24 rotates smoothly. Referring to FIG. 8, it is illustrated that the bearing 27 is a ball bearing which has the same effect as those from the bearing 26.

By above mentioned structure, the vises of the present invention can be operated as the conventional way. In use, a work piece is clamped between the main clamping plate 217 and the sub-clamping plate 223. The handle 25 is rotated so as to drive the threaded rod 24 to rotate and thus the sliding body 22 moves forwards or backwards. If the main clamping plate 217 moves toward the sub-clamping plate 223, the work piece is clamped. On the contrary, the work piece is released.

By the main clamping arm 215 and the sub-clamping plate 223 of the present invention, a work piece can be clamped tightly with releasing from the vises so hat the operator can operate easily without effect by the length of the work piece.

A main clamping arm 215 and the sub-clamping plate 223 can clamp a large work piece by the large clamping area. The longitudinal trenches 218 serve to clamp a round work piece.

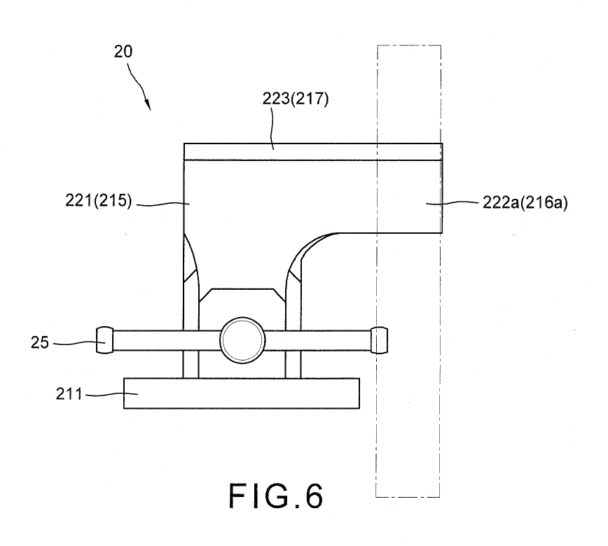

Referring to FIG. 6, it is illustrated that the main extension arm 216a and the sub-extension arm 222a can be enlarged at another side so as to suit for a working table at the right side.

Other that the main clamping arm 215 and the sub-clamping arm 221 are symmetrical as the conventional way, the present invention is also added with a main clamping plate and a sub-clamping plate so as to clamp a large work piece. Moreover, the threaded rod 24 can rotate smoothly. The friction force is reduced and the handle 25 can be operated easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vises comprising:
a main body having:
a base;
a sliding track installed on the base; a lower side of the sliding track being formed with a sliding groove;
a main clamping arm extending upwards from the sliding track;
a main extension arm extending at an upper side of the main clamping arm;
a threaded rod connected to a lower side of the sliding body; the threaded rod being screwed to a threaded hole in the sliding track; an end portion of the threaded rod having a handle for driving the threaded rod to rotate so as to move the sliding body forwards and backwards;
a sub-clamping arm extending from an upper side of the sliding body; a sub-extension arm extending from sub-clamping arm and toward the main extension arm of the main clamping arm;
a sliding body having a part received in the sliding groove of the sliding track;
wherein the main extending arm is extended toward the sub-extending arm; and the main clamping arm is symmetrical to the sub-clamping arm; and therefore, the main extension arm and the sub-extension arm can clamp a large work piece steadily without releasing.

2. The vises as claimed in claim 1, wherein a main clamping plate is screwed to an inner side of the main extension arm.

3. The vises as claimed in claim 2, wherein an inner side of the main clamping plate is formed with a plurality of longitudinal trenches and a plurality of transversal trenches.

4. The vises as claimed in claim 1, wherein an inner side of the sub-extension arm has a sub-clamping plate.

5. The vises as claimed in claim 1, wherein a positioning ring is installed at one end of the threaded rod; a spring is wound around the threaded rod and is installed between the positioning ring and a lower inner side of the sliding body; a rear end of the threaded rod is installed with another positioning ring for stopping the protruding block.

6. The vises as claimed in claim 1, wherein a protruding block extends upwards from the base; and the threaded hole is formed in the protruding block.

7. The vises as claimed in claim 1, wherein an end portion of the threaded rod attached to the main body has a bearing which surround the end portion of the threaded rod.

8. The vises as claimed in claim 7, wherein the bearing is a ball bearing.

9. The vises as claimed in claim 7, wherein the bearing is a cylindrical round post bearing.
